(19) United States
(12) Patent Application Publication
(10) Pub. No.: US 2005/0204928 A1
(43) Pub. Date: Sep. 22, 2005

(54) Cooking utensil the covering of which comprise an ornamental piece and corresponding production method

(75) Inventors: Alain Gilles Bourdin, Saint Seine Sur Vingeanne (FR); Jean-Francois Marie Poty, Dijon (FR)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: SEB S.A., Ecully Cedex (FR)

(21) Appl. No.: 10/514,519

(22) PCT Filed: Mar. 9, 2004
(86) PCT No.: PCT/FR04/00558

§ 371 Date: Nov. 15, 2004

(30) Foreign Application Priority Data
Mar. 10, 2003 (FR) 03/03069

(51) Int. Cl. A47J 37/12

(52) U.S. Cl. 99/403

(57) ABSTRACT

A device for cooking food is disclosed herein. The device comprises a vessel provided with a bottom having an internal face and an opposed external face. The device also comprises a base having an intermediate layer fastened to the external face and a surface layer fastened to and covering the intermediate layer. The surface layer is pierced by at least one aperture, which is intended to fitted with an ornamental piece that is directly bonded, by a hot pressing operation, to the intermediate layer so that the ornamental piece extends so as to be continuous with the surface layer.

### TECHNICAL FIELD

The present invention relates to the general technical field of devices for heating and/or cooking food for domestic use, such utensils being intended to cook and/or heat liquid or solid food substances.

The present invention relates more particularly to a device for cooking food, comprising:
a vessel intended to hold the food and provided with a bottom having an internal face and an opposed external face, said external face being intended to be placed facing a heating means;
a base attached to the external face and comprising, on the one hand, an intermediate layer fastened to the external face and, on the other hand, a surface layer fastened to the intermediate layer and covering the latter.

The invention also relates to a process for manufacturing a device for cooking food, comprising at least the following steps:
a) production or supply of a vessel intended to hold the food and provided with a bottom having an internal face and an opposed external face, said external face being intended to be placed facing a heating means;
b) positioning of an intermediate layer against said external face;
c) fastening of the intermediate layer to the external face;
d) covering of the intermediate layer with a surface layer;
e) fastening of the surface layer to the intermediate layer.

### PRIOR ART

It is already known to produce devices for cooking food comprising a vessel intended to hold the food for the purpose of cooking or heating it, said vessel being provided with a bottom having an internal face and an opposed external face, said external face being intended to be placed facing a heating means, of the hob kind or the like. As examples of such devices, mention may be made of pressure cookers, the container of which constitutes a cooking vessel, saucepans, skillets, cooking pots or even kettles.

To promote durability of such a cooking device, it is desirable to make the vessel of this cooking device from a material exhibiting good in-service durability relating to the stresses to which a domestic cooking utensil is subjected. These stresses are of a mechanical nature (various knocks, being put in a dishwasher), of a thermal kind (cooking cycles, sudden cooling by being put under cold water after a cooking cycle) or of the chemical kind (oxidation or corrosion phenomena encouraged by the washing operations, especially in a dishwasher, and by contact with food).

Since stainless steel is a material having, besides compatibility with food and an attractive shiny appearance, very good in-service durability properties relating to the various aforementioned stresses, it has of course been very often used for manufactured cooking vessels. This is especially the case for pressure cookers, the container of which is generally made from stainless steel. However, stainless steel has unremarkable, or even mediocre, properties as regards heat transmission, especially compared with aluminum or copper, both of these having, in contrast, excellent thermal conduction properties, but poor in-service durability properties.

Consequently, producing a cooling vessel made of stainless steel gives the cooking device cooking properties that are not optimal since a not insignificant fraction of the heat federated by the heating device, of the hob kind, will not be transmitted to the food contained properties of stainless steel from which this vessel is made.

To get round this problem, it has been proposed to provide the bottom of stainless steel cooking vessels with a base intended to improve the thermal characteristics, and therefore the quality of the cooking, of devices provided with such a vessel. For this purpose, the base is attached to the bottom of the vessel and comprised, on the one hand, an intermediate layer made of aluminum (and there fore exhibiting excellent thermal qualities) and on the other hand, a protective surface layer made of stainless steel, which is fastened to the intermediate layer and covers the latter, In this way, the bottom of the pressure cooker benefits from the good thermal conduction properties of aluminum, while still maintaining an external protective jacket made if stainless steel, which guarantees good in-service durability of the assembly. Aluminum, which has mediocre in-service durability properties, especially as regards oxidation, corrosion and rigidity, is completely “sandwiched” between the bottom of the container on the one hand, and the stainless steel surface layer on the other, thereby insulating it and completely protecting it from the external environment.

Such an arrangement is generally satisfactory, since it does achieve a useful compromise between in-service durability properties and thermal transmission properties.

Moreover, to improve the overall esthetics of such a cooking device, it is known to decorate the external face (i.e. that intended to be in contact with the hob) of the base described above. This decoration may especially consist in attaching, to this stainless steel external face, a thin metal disk. Such a decoration process is described in European patent specification EP-613 752. That document thus describes the production of a decorated base obtained by superposing, on the external face of the bottom of a cooking vessel, an aluminum plate, a stainless steel dish and a decorative metal disk. The whole assembly is heated and then subjected to pressure in order to bond the various aforementioned elements together.

In this way, a cooking utensil is obtained in which the surface of its base has an indented slot for demarcation between the metal disk and the stainless steel surface of the surface dish. This indented slot, which follows the outline of the metal disk, thus constitutes a decorative pattern.

However, a utensil decorated in this way has the following drawbacks.

The presence of an indented slot, of the groove kind, in the base promotes the retention of soil, especially coming from food, or quite simply water and/or washing products. Besides the quite understandable unpleasantness that this causes the user, such retention of soil may also be of the type to promote oxidation and/or corrosion phenomena.

Moreover, the addition of a further metal disk against the outer dish of the base adds a further thickness between the aluminum layer present in the base and the hob, which adversely affects the thermal properties of the cooking device.

Finally, when the metal disk attached to the dish is made of copper, something which proves to be particularly desirable and sought after since the visual appearance of copper is intimately associated with the world of cuisine, it is necessary to position a bonding film between the stainless steel dish and the copper disk. This is because the affinity for bonding between copper and stainless steel is not sufficient for the copper disk to be correctly embedded in the stainless steel dish following the manufacturing process described above. The addition of a bonding layer, for example made of aluminum, between the copper and stainless steel then makes the manufacturing process complicated and increases the cost of the cooking device.

### SUMMARY OF THE INVENTION

The objects of the invention are consequently to avoid the various drawbacks itemized above and to propose a novel device for cooking food whose base is decorated and has a continuous surface free of asperities or anfractuosities.

Another object of the invention is to propose a novel cooking device with a decorated base whose appearance is particularly attractive.

Another object of the invention is to propose a novel cooking device with a decorated base whose thermal properties are improved.

Another object of the invention is to propose a novel cooking appliance whose decorative base has improved durability.

Another object of the invention is to propose a novel cooking device with a decorated base compatible with induction heating means.

Another object of the invention is to propose a novel cooking device whose design and manufacture are particularly simple and inexpensive.

Another object of the invention is to propose a novel process for manufacturing a cooking device with a particularly simple decorated base that is rapid and inexpensive to implement.

Another object of the invention is to propose a novel process for manufacturing a cooking device with a decorated base allowing a large variety of decorations to be produced.

Another object of the invention is to propose a novel process for manufacturing a device for cooking food having a decorated base whose implementation can be carried out using conventional industrial means.

The objects of the invention are achieved using a device for cooking food, comprising:
a vessel intended to hold the food and provided with a bottom having an internal face and an opposed external face, said external face being intended to be placed facing a heating means;
a base attached to the external face and comprising, on the one hand, an intermediate layer fastened to the external face and, on the other hand, a surface layer fastened to the intermediate layer and covering the latter,
   the surface layer being pierced by at least one aperture, which is intended to take, so as to be more or less closely fitted therein, an ornamental piece bounded by a lateral periphery 100, characterized in that said ornamental piece 7 is directly bonded, by a first hot pressing operation, to the intermediate layer 5 so that, on the one hand, the ornamental piece 7 extends substantially so as to be continuous with the surface layer 6 and, on the other hand, the lateral periphery 100 of the ornamental piece 7 is bonded intimately with and directly to the surface layer 6.

The objects of the invention are also achieved using a process for manufacturing a device for cooking food, comprising at least the following steps:
a) production or supply of a vessel intended to hold the food and provided with a bottom having an internal face and an opposed external face, said external face being intended to be placed facing a heating means;
b) positioning of an intermediate layer against said external face;
c) fastening of the intermediate layer to the external face;
d) covering of the intermediate layer with a surface layer;
e) fastening of the surface layer to the intermediate layer; said process including:
   prior to step-d), a step f) of perforating the surface layer so that it is pierced by at least one aperture, or a step of supplying a pre-perforated surface layer;
   after step d), a step g) of positioning, in a more or less closely fitted manner, at least one ornamental piece bounded by a lateral periphery in the corresponding aperture,
      said process being characterized in that it includes, after step g), a step h) of directly fastening, by a first hot pressing operation, at least the intermediate layer to the ornamental piece so that, on the one hand, the ornamental piece extends substantially so as to be continuous with the surface layer and, on the other hand, the lateral periphery of the ornamental piece is bonded intimately with and directly to the surface layer.

### BRIEF DESCRIPTION OF THE DRAWINGS

Other features and advantages of the invention will appear in greater detail on reading the following description, with reference to the appended drawings given by way of illustrative but non-limiting examples, in which:

FIGS. 1 and 2 illustrate, chronologically and in a schematic view in vertical section, steps of the process for manufacturing a cooking device according to the invention;

FIG. 3 illustrates, in a schematic view in vertical section, a food cooking device according to the invention;

FIG. 4 illustrates, in a view from below, a cooking device according to the invention; and

FIGS. 5 to 7 illustrate various alternative embodiments of apertures in the surface layer of the base of the cooking device according to the invention.

### BEST WAY OF REALIZING THE INVENTION

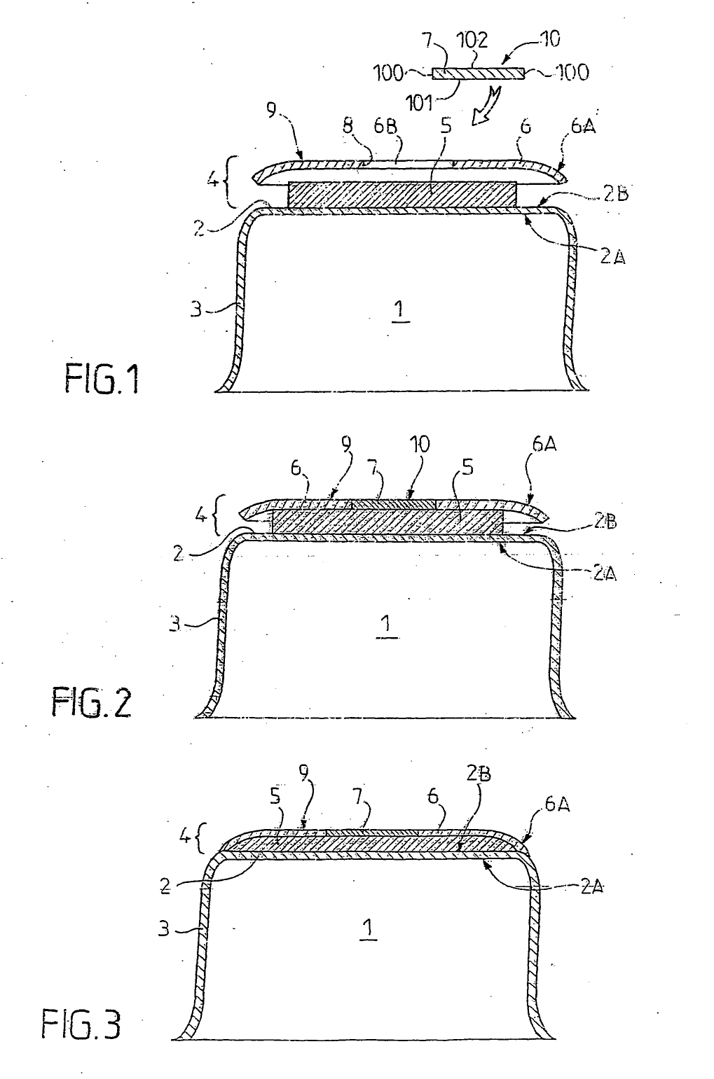

FIGS. 1 to 4 illustrate a cooking device according to the invention and in various stages of manufacture, FIG. 3 showing a cooking device after its manufacture has been completed.

As may be seen in the figures, the device for cooking food according to the invention comprises a vessel 1 intended to hold the food that it is desired to cook or simply heat up.

The vessel 1 is provided with a bottom 2 having an internal face 2A and an opposed external face 2B, said external face 2B being intended to be placed facing a heating means, of the hob kind (whether a gas, electric, glass-ceramic or induction hob), burner, hotplate or the like.

The cooking device according to the invention therefore has two functions, namely a function of holding and/or supporting food and a function of transmitting to this food the thermal energy generated by the external heating means. The invention relates to any cooking device having these two functions. The cooking device according to the invention may especially consist of one of the utensils from the following group: pressure cookers, saucepans, skillets, cooking pots, or even kettles. In the case of a pressure cooker, the vessel 1 constitutes the container of the pressure cooker.

Conventionally, the vessel 1 may be bounded by outer walls 3 rising approximately vertically from the bottom 2.

Preferably, the vessel 1 is made from a first material exhibiting good in-service durability properties, of the mechanical strength or corrosion resistance type. This first material, from which the vessel 1 is made, will preferably chosen to be resistant, durably over time, to all the stresses to which domestic cooking utensils are usually subjected (cooking cycles, washing operations, knocks, etc.).

Preferably, said first material, from which the vessel 1 is made, is based on or consists entirely of stainless steel. Advantageously, this first material is an austenitic stainless steel.

According to the invention, the food cooking device includes a base 4 attached to the external face 2B of the bottom 2. The base 4 allows the food cooking device to rest in a stable manner on an approximately flat supporting surface, and especially on a heating means of the hob kind.

According to the invention, the base 4 comprises, on the one hand, an intermediate layer 5, being for example in the form of a plate or a stack of plates, or else of a series of separate pads. The intermediate layer 5 advantageously covers, as shown in the figures, almost all of the external face 2B of the bottom 2. However, it is conceivable, without thereby departing from the scope of the invention, for the intermediate layer 5 to cover only a fraction of the external face 2B of the bottom 2. The intermediate layer 5 is fastened to the external face 2B either at discrete points or, more preferably, in a substantially uniform manner over the entire contact interface between the intermediate layer 5 and the external face 2B.

Advantageously, the intermediate layer 5 is made from a material that is a good heat conductor. Preferably, said good conductor is based on or consists of aluminum or copper, or else a combination of these two materials, in the form of a co-laminated complex for example.

According to the invention, the base 4 comprises, on the one hand, a surface layer 6 covering the intermediate layer 5, in such a way that the intermediate layer 5 is inserted between, on one side, the external face 2B of the bottom 2 and, on the other side, the surface layer 6.

Advantageously, the surface layer 6 is in the form of a plate, the edge 6A of which is preferably curved so as to completely encompass the intermediate layer 5, the edge 6A conforming to the periphery of the external face 2B of the bottom 2. Advantageously, the surface layer 6 is made from a second material exhibiting good in-service durability properties, of the mechanical strength and corrosion resistance kind. This second material must preferably be chosen so as to have properties substantially similar, from the standpoint of in-service durability and long life, to those of the material used for producing the vessel 1. Advantageously, this second material is based on or consists entirely of stainless steel.

Advantageously, this second material exhibits magnetic properties, of the magnetic permeability kind, so that the cooking device is compatible with an induction heating means. Preferably, this second material is a ferritic stainless steel.

According to the invention, the surface layer 6 is fastened to the intermediate layer 5 at discrete points, or more preferably in a substantially uniform manner over the entire contact interface between the intermediate layer 5 and the surface layer 6.

According to one important feature of the invention, the surface layer 6 is perforated, that is to say pierced by at least one aperture 6A-D, namely an orifice of defined shape passing all the way through the thickness of the surface layer 6.

FIGS. 5 to 7 illustrate, in a non-limiting manner, various embodiments of one or more apertures 6A-D. It is thus conceivable, as shown in FIGS. 1 and 6, for the aperture 6B to be in the form of a hole passing right through the thickness of the surface layer 6. This hole may be of any cross section, and especially of circular cross section. As shown in FIG. 5, the aperture may be complex, that is to say it may have variations and modifications of cross section through the thickness of the surface layer 6. In the case of the example of the aperture 6A shown in FIG. 5, the aperture 6A is, up to the mid-thickness of the surface layer 6, in the form of a simple orifice which then communicates, over the remaining half-thickness, with a multitude of orifices of smaller cross section 60A-N which are arranged for example in the manner of a grid. As shown in FIG. 7, it is also quite conceivable to produce several apertures 6C, 6D of different shapes in the surface layer 6, and especially an aperture 6D of circular cross section surrounded by an annular aperture 6C.

The aperture or apertures 6A-D are each intended to take, in a more or less closely fitted manner, a corresponding ornamental piece bounded by a lateral periphery 100. This ornamental piece 7 may advantageously be in the form of a solid plate extending axially between a lower face 101, intended to come into contact with the intermediate layer 5, and an opposed upper face 102, said lower and upper faces 101, 102 being joined by a side wall forming the lateral periphery 100.

However, this ornamental piece may, without thereby departing from the scope of the invention, be in the form of a plate provided with holes or with a grid, or else be in the form of a series of separate pads.

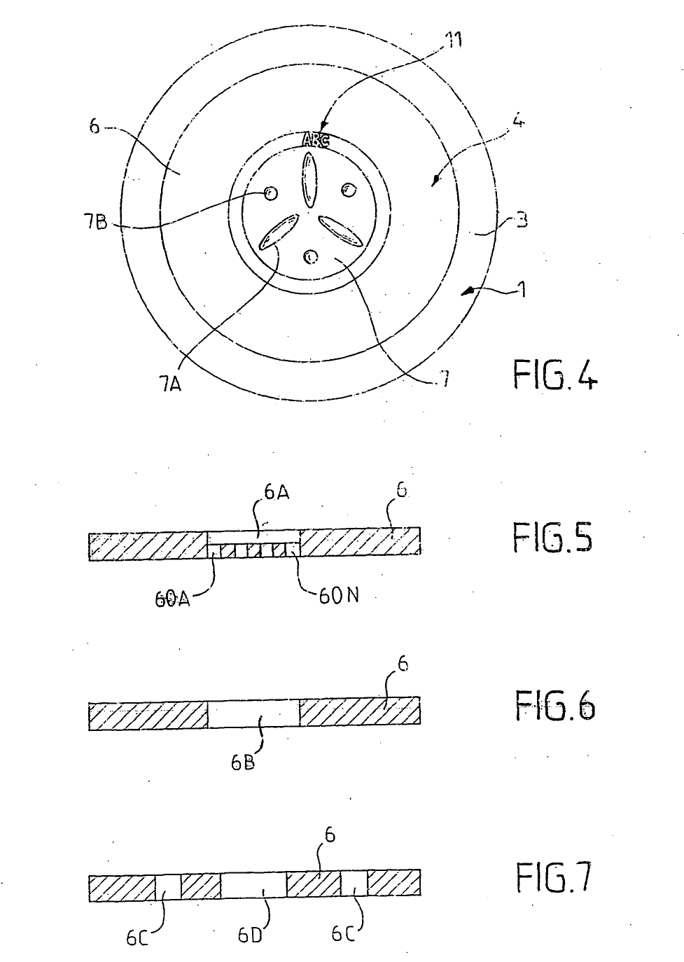

As illustrated in FIG. 4, the ornamental piece 7 may be in the form of a plate provided with decorations 7A, 7B that appear as indented or raised features.

Advantageously, the ornamental piece 7 is made from one or more materials of the following group: copper, titanium, brass, iron, nickel, steel, this list not, of course, being in any way limiting.

When several separate ornamental pieces are fitted into their corresponding apertures, it is quite conceivable, within the context of the invention, for these ornamental pieces to be made from different materials. Thus, it is possible to envision a central plate made of copper and peripheral plates made of brass or steel for example. It is also quite conceivable for an ornamental piece 7 to be formed from several sheets of different materials co-laminated to form the multilayer complex.

Preferably, the cooking device according to the invention will have a single ornamental piece 7, in the form of a solid, i.e. non-perforated, plate positioned in a corresponding aperture 6B made approximately at the center of the surface layer 6.

In what follows, reference will be made, for reasons of ease of description, to a base provided with a single ornamental piece 7. However, as mentioned above, the invention is not limited in any way to this single configuration.

According to one important feature of the invention, the ornamental piece 7 is directly bonded, by a hot pressing operation, to the intermediate layer 5 so that the intermediate piece 7 extends substantially so as to be continuous with the surface layer 6.

Hot pressing is a technique well known to those skilled in the art. It consists in particular in heating objects and applying pressure to them, for example using a press, in order to bind them together.

Within the context of the invention, the relative dimensions of the surface layer 6, of the ornamental piece 7 and of the aperture 6B are preferably chosen so that, after the first hot pressing operation, the ornamental piece 7 conforms to the edge 8 of the aperture 6B and is substantially flush with the outer surface 9 of the surface layer 6 in such a way that the flush surface 10 of the piece 7 lies approximately at the same level as that of the region of the outer surface 9 with which it is contiguous. In this way, while still isolating the intermediate layer 5 from the external environment, the continuity between the outer envelope 9, 10 of the base 4 is provided without demarcation of the groove kind, or undesirable anfractuosities.

In other words, the hot pressing operation, which, as will be seen later, is preferably a hot stamping operation, makes it possible, on the one hand, to bond the lower face 101 intimately with and directly to the intermediate layer 5 and, on the other hand, to bring about direct lateral bonding of the piece 7 to the surface layer 6 in such a way that the lateral periphery 100 of the ornamental piece 7 is bonded intimately with and directly to the surface layer 6.

In addition, the joining of the intermediate layer 5 with the ornamental piece 7 by hot pressing makes it possible to achieve intimate bonding, which could be termed atomic bonding, between these two elements, which, especially when this intimate bonding is made to be uniform over the entire contact interface between the ornamental piece 7 and the intermediate layer 5, makes it possible to optimize the transfer of thermal energy from the external heating means into the vessel 1 via the intermediate layer 5.

Preferably, the first hot pressing operation is a hot stamping operation. Hot stamping is a technique well-known to those skilled in the art. It consists in rapidly applying a compressive load, which can be likened to a blow, to hot parts.

Advantageously, the surface layer 6 is also fastened directly to the intermediate layer 5 by a second hot pressing operation, preferably in a substantially uniform manner over the entire contact interface between the surface layer 6 and the intermediate layer 5.

Preferably, the second hot pressing operation is a hot stamping operation. However, it is quite conceivable, without departing from the scope of the invention, for the surface layer 6 to be fastened to the intermediate layer 5 by any other means, for example by brazing.

Advantageously, the intermediate layer 5 is also fastened directly to the external face 2B of the bottom 2 by a third hot pressing operation, preferably in a substantially uniform manner over the entire contact interface between the intermediate layer 5 and the external face 2B of the bottom 2.

Preferably, the third hot pressing operation is a hot stamping operation. However, it is quite conceivable, without departing from the scope of the invention, for the intermediate layer 5 to be fastened to the external face 2B by any other means, for example by brazing.

Even more preferably, the external face 2B of the bottom 2, the intermediate layer 5, the surface layer 6 and the ornamental piece 7 are fastened together, in a substantially uniform manner over all their respective contact interfaces, by a single common hot pressing operation. In this way, the ornamental piece 7 is intimately bonded both to the surface layer 6 (laterally) and above all to the intermediate layer 5, whereas this intermediate layer 5 is intimately bonded to the external face 2B of the bottom 2, the surface layer 6 being also fastened peripherally to the external layer 2B of the bottom 2.

Advantageously, this single common hot pressing operation is a hot stamping operation.

The base 4 of the cooking device according to the invention thus has a unitary and one-piece character, in which the materials (which may all be different) of which these various elements are intimately and directly bonded together, involving interpenetration phenomena that could be termed atomic bonding, thereby optimizing in particular the overall mechanical and thermal conduction properties of the base 4. These properties may be appreciably improved when the decorative piece 7 is made from a material exhibiting good thermal conduction properties, such as copper. This is because a preferential thermal connection will thus be established between the external heating means (for example a hob) and the intermediate layer 5, since the latter is intimately bonded to a good conductor forming the decorative element 7.

The invention also relates to a process for manufacturing a device for cooking food. The manufacturing process according to the invention-comprises at least the following steps:
a) production of a vessel 1 intended to hold the food and provided with a bottom 2 having an internal face 2A and an opposed external face 2B, said external face 2B being intended to be placed facing a heating means (not shown);
b) positioning of an intermediate layer 5 against said external face, as shown in FIG. 1;
c) fastening of the intermediate layer 5 to the external face 2B;
d) covering of the intermediate layer 5 with a surface layer 6, as illustrated in FIG. 1;
e) fastening of the surface layer 6 to the intermediate layer 5, as illustrated in FIG. 2.

Of course, it is also possible to start the process with a vessel already produced beforehand, without departing from the scope of the invention.

In this case, step a) will simply comprise the supplying of the vessel 1.

Of course, it is also conceivable for additional layers, for example of bonding, soldering or brazing materials, to be inserted between the external face 2B of the bottom 2 and the intermediate layer 5, or else between the intermediate layer 5 and the surface layer 6, without thereby departing from the scope of the invention.

According to an important feature of the invention, the manufacturing process includes, prior to step d), a step f) of perforating the surface layer 6 so that it is pierced by at least one aperture 6A-D. The perforation of the surface layer 6 may be carried out using any method known to those skilled in the art, and especially by cutting or punching. FIGS. 5 to 7 illustrate various possible ways of producing perforations, that is to say holes passing right through the thickness of the surface layer 6. Of course, it is conceivable, without departing from the scope of the invention, for the surface layer 6 to be perforated beforehand separately from the series of steps of the process according to the invention. In this case, step f) comprises simply the supplying of a pre-perforated surface layer 6.

The process according to the invention also includes, after step d), a step g) in which at least one ornamental piece 7 is positioned, in a more or less closely fitted manner, in a corresponding aperture 6B, as shown in FIG. 2.

In what follows, for reasons of ease of description, this will be limited to describing a surface layer provided with a single aperture 6B into which a single ornamental piece 7 is inserted of course, the number, shape and arrangement of the apertures, and also the corresponding ornamental pieces, are not in any way limited within the context of the invention.

According to the invention, the process includes, after step g), a step h) of fastening, by a first hot pressing operation, at least the intermediate layer 5 to the ornamental piece 7 so that, on the one hand, the ornamental piece 7 extends substantially so as to be continuous with the surface layer 6 and, on the other hand, the lateral periphery 100 of the ornamental piece 7 is bonded intimately with and directly to the surface layer 6, in particular without interposition of a third material (of the welding kind) between the periphery 100 and the surface layer 6.

In other words, the lateral periphery 100 is fastened to the surface layer 6 exclusively by the first hot pressing operation, so that the inventive process does not require the implementation, prior to said hot pressing operation, of a preliminary operation of fixing the ornamental piece 7 relative to the surface layer 6.

The first hot pressing operation is therefore sufficient to adjoin the lateral periphery 100 to the surface layer 6 in such a way as to meet all the functional requirements (sealing) and esthetic requirements (sharp visual delimitation between the various parts) that are required in the technical field, without addition of further materials.

Advantageously, the first hot pressing operating is a hot stamping operation.

Hot pressing, and more particularly hot stamping, techniques are well known to those skilled in the art and will therefore not be explained in greater detail here. As a reminder, hot pressing consists firstly in heating the parts to be joined together and/or deformed in order to make them more malleable and secondly in applying pressure to them using, for example, a forging press, of the screw press or “kinetic energy” press kind, in order to bond said elements intimately together, especially within their microscopic structures, while also possibly forming them.

Hot stamping is a method of hot pressing in which the compression, or pressing operation, is carried out rapidly in the manner of an impact.

A person skilled in the art will choose the relative dimensions of the ornamental piece 7 and the aperture 6B in such a way that, after the hot stamping operation the ornamental piece 7 intimately conforms to the edges of the aperture 6B, while still being bonded, preferably uniformly, over the entire contact interface between said ornamental piece 7 and the intermediate layer 5 by bonding, of the atomic bonding kind, with the intermediate layer 5.

A person skilled in, the art will also choose the respective thicknesses of the ornamental piece 7 and of the surface layer 6, or at least of that region of the surface layer 6 adjacent the periphery of the aperture 6B, so that the ornamental piece 7, after the hot stamping, extends so as to be continuous with, that is to say approximately at the same level as, the outer surface 9 of that region of the surface layer 6 surrounding the aperture 6B.

Advantageously, step e) is carried out by a second hot pressing operation, which is preferably a hot stamping operation.

It is preferred for the preferably direct fastening of the surface layer 6 to the intermediate layer 5 to be carried out in such a way that it is substantially uniform over the entire contact interface between said intermediate layer 5 and the surface layer 6.

Advantageously, step c) of the process according to the invention is carried out by a third hot pressing operation, which is preferably a hot stamping operation.

It is preferred for this operation to be carried out so as to fasten, preferably directly, the intermediate layer 5 to the external face 2B of the bottom 2 in a substantially uniform manner over the entire contact interface between the intermediate layer 5 and the external face 2B.

Particularly advantageously, steps c), e) and h) are carried out simultaneously by a single common hot pressing operation, or more preferably by a single hot stamping operation. Thus, exclusively by means of a simple stacking of the elements making up the cooking device, followed by a single hot stamping operation, the invention makes it possible to obtain a cooking device with excellent usage properties and a very attractive visual appearance.

Advantageously, the process according to the invention includes a step i) that preferably takes place at the latest concomitantly with step d).

In this step i), a dish-shaped surface layer 6 is produced so that, during step d) and/or step e), the surface layer 6 is capable of encompassing the intermediate layer 5, by bearing peripherally against the external face 2B of the bottom 2. In this way, the surface layer 6 completely isolates the intermediate layer 5 from the external environment, thereby helping to protect said intermediate layer 5.

However, it is quite conceivable for the surface layer 6 not to have the shape of a dish, that is to say it does not include a bent-up edge 6A, as shown in FIGS. 5 to 7, without departing from the scope of the invention.

Advantageously, steps c), e), h) and i) are carried out simultaneously by a single hot pressing operation. In this case, the hot pressing operation, apart from the fact that it ensures intimate bonding between the various elements in question, also forms the dish 6, for example from a flat blank.

Preferably, this single hot pressing operation is a hot stamping operation.

Advantageously, steps a), c), e), h) and i) are carried out simultaneously by a single common hot pressing operation, which is preferably a hot stamping operation.

In this case, the hot pressing operation allows, besides the intimate bonding between all the elements of the device in question, the forming of the vessel 1, for example from a flat blank.

Preferably, the vessel 1, the intermediate layer 5, the surface layer 6 and the ornamental piece 7 are produced from metal blanks, which are in the form of single-material or multi-material flat sheets.

Preferably, the vessel 1 is produced from a blank made of austenitic stainless steel.

Preferably, the intermediate layer 5 is produced from a blank made from aluminum and/or copper.

Preferably, the surface layer 6 is made from a blank made of ferritic stainless steel, so as to impart properties of compactability with devices for induction heating the cooking device.

Preferably, the ornamental piece 7 is made from a blank based on one or more of the following materials: copper, titanium, brass, iron, nickel, steel.

Of course, it is quite conceivable to choose different materials for the aforementioned elements, without thereby departing from the scope of the invention.

The manufacturing process according to the invention thus makes it possible to produce, very simply and less expensively, all known cooking utensils, for domestic or professional use, which are intended to transfer to food heat produced by an external heating means, of the hob kind.

The manufacturing process according to the invention will allow in particular the manufacture of utensils from the following group: pressure cookers, saucepans, skillets, cooking pots and kettles, this list being, of course, in no way limiting.

An example of how a cooking device according to the invention is produced will now be described.

A cooking vessel 1 provided with a bottom 2 having an internal face 2A and an external face 2B is supplied.

The vessel 1 has been obtained separately, in a conventional manner, by deep-drawing an austenitic stainless steel blank. The thickness of the shell forming the vessel 1 is, for example, between 0.5 and 1.5 mm. The vessel 1 has symmetry of revolution. However, it may be oval or polygonal.

Next, an aluminum blank 5, the thickness of which is for example between 3 and 10 mm, is deposited on the external face 2B of the bottom 2.

Next, a protective dish 6 made of ferritic stainless steel, the thickness of which is for example between 0.4 mm and 1 mm, is deposited on this aluminum blank. The dish 6 is in the form of a blank that has been apertured beforehand, that is to say pierced by a through orifice 6B.

A solid copper blank 7, the thickness of which is similar to that of the dish, is introduced into this orifice 6B. The dimensions of the blank forming the decorative element 7 are chosen so as to fit more or less closely the outline of the aperture 6B.

The assembly comprising the elements forming the stack described above is then heated to a temperature above 400° C., for example between 440 and 460° C.

The stack is then subjected to a pressing operation between an anvil that bears on the internal face 2A of the bottom 2 and an impression that bears on the outer surfaces 9, 10 of the surface layer 6 and of the decorative element 7. The compressive force is exerted by a “kinetic energy” press that develops, for example, a pressure of around 900 to 1000 tons.

Under the effect of this pressure, the blanks 5, 6, 7 deform and become intimately bonded with one another, in such a way that the edges 6A of the dish 6 conform to and are intimately bonded to the external face 2B of the bottom 2, whereas the gap between the external face 2B of the bottom 2 and the surface layer 6 is uniformly and completely filled with the aluminum of the blank 5, which flows under the combined effect of the heat and pressure. The decorative element 7 is itself spread out, so as to conform uniformly and directly to the edges of the orifices 6B. The decorative element 7 is also intimately and uniformly bonded to the intermediate layer 5. Finally, it should be noted that the gap between the decorative element 7 and the aperture 6B is chosen so as to avoid any leakage of aluminum coming from the blank 5 through said gap during the hot stamping operation.

It is also possible, during the hot stamping operation, to create, as indentation and/or relief, decorative features 11 directly in the surface layer 6. Such features may consist, for example, of various inscriptions, as shown in FIG. 4.

Thus, the invention makes it possible to obtain a cooking device having a compact decorated base 4 with substantially no hollow or void in its internal structure, thereby allowing optimum heat transfer to the internal face of the bottom 2A. In addition, the intimate bonding between the decorative element 7, which may also be a very good heat conductor, and the main heat conduction element formed by the intermediate layer 5 makes it possible to improve the thermal properties of the base, while still allowing the latter to be durable in service, thanks to the presence of a protective surface layer 6 made of stainless steel.

Finally, it should be noted that said surface layer 6, owing to its apertures, also makes it possible to obviate the additional thickness that the fitted decorative element 7 could constitute, in such a way that the cooking device, when finished, has an overall flat base surface.

### INDUSTRIAL APPLICABILITY

The industrial application of the invention lies in the manufacture of utensils intended for cooking, especially for cooking food.

1. A device for cooking food, the device comprising:
a vessel (1) intended to hold the food and provided with a bottom (2) having an internal face (2A) and an opposed external face (2b), said external face (2B) being intended to be placed facing heating means;
a base (4) attached to the external face (2B) and comprising, on the one hand, an intermediate layer (5) fastened to the external face (2B) and, on the other hand, a surface layer (6) fastened to the intermediate layer (5) and covering the latter, the surface layer (6) being pierced by at least one aperture (6A-D), which is intended to take, so as to be more or less closely fitted therein, an ornamental piece (7) bounded by a lateral periphery (100);
wherein said ornamental piece (7) is directly bonded, by a first hot pressing operation, to the intermediate layer (5) so that, on the one hand, the ornamental piece (7) extends substantially so as to be continuous with the surface layer (6) and, on the other hand, the lateral periphery (100) of the ornamental piece (7) is bonded intimately with and directly to the surface layer (6).

2. The device as claimed in claim 1, wherein the first hot pressing operation is a hot stamping operation.

3. The device as claimed in claim 1, wherein the surface layer (6) is fastened directly to the intermediate layer (5) by a second hot pressing operation, which is preferably a hot stamping operation.

4. The device as claimed in claim 1, wherein the intermediate layer (5) is fastened directly to the external face (2B) by a third hot pressing operation, which is preferably a hot stamping operation.

5. The device as claimed in claim 1, wherein the external face (2B) of the bottom (2), the intermediate layer (5), the surface layer (6) and the ornamental piece (7) are fastened together, in a substantially uniform manner over all their respective contact interfaces, by a single common hot pressing operation.

6. The device as claimed in claim 1, wherein said intermediate layer (5) is made from a material that is a good heat conductor, for example one based on aluminum and/or copper.

7. The device as claimed in claim 1, wherein the vessel (1) is made from a first material exhibiting good durability properties in service, of the mechanical strength and corrosion resistance kind.

8. The device as claimed in claim 7, wherein said first material is based on austenitic stainless steel.

9. The device as claimed in claim 1, wherein the surface layer (6) is made from a second material exhibiting good durability properties in service, of the mechanical strength and corrosion resistance kind.

10. The device as claimed in claim 9, wherein said second material is a ferritic stainless steel.

11. The device as claimed in claim 1, wherein the ornamental piece (7) is made from one or more of the materials from the following group: copper, titanium, brass, iron, nickel, steel.

12. The device as claimed in claim 1, wherein the ornamental piece (7) comprises a plate positioned in an aperture (6B) made approximately at the center of the surface layer.

13. The device as claimed in claim 1, wherein it consists of one of the utensils of the following group: pressure cooker, saucepan, skillet, cooking pot, kettle.

14. A process for manufacturing a device for cooking food, the process comprising:
a) producing or supplying a vessel (1) intended to hold the food, the vessel (1) and provided with a bottom (2) having an internal face (2A) and an opposed external face (2B), said external face (2B) being intended to be placed facing heating means;
b) positioning an intermediate layer (5) against said external face (2B);
c) fastening the intermediate layer (5) to the external face (2B);
d) covering the intermediate layer (5) with a surface layer (6);
e) fastening the surface layer (6) to the intermediate layer (5);
f) prior to step d), perforating the surface layer (6) so that it is pierced by at least one aperture (6A-D), or a step of supplying a pre-perforated surface layer (6);
g) after step d), positioning, in a more or less closely fitted manner, at least one ornamental piece (7) bounded by a lateral periphery (100) in the corresponding aperture (6B); and
h) after step g), directly fastening, by a first hot pressing operation, at least the intermediate layer (5) to the ornamental piece (7) so that, on the one hand, the ornamental piece (7) extends substantially so as to be continuous with the surface layer (6) and, on the other hand, the lateral periphery (100) of the ornamental piece (7) is bonded intimately with and directly to the surface layer (6).

15. The process as claimed in claim 14, wherein the first hot pressing operation is a hot stamping operation.

16. The process as claimed in claim 14, wherein step e) is carried out by a second hot pressing operation, which is preferably a hot stamping operation.

17. The process as claimed in claim 16, wherein step c) is carried out by a third hot pressing operation, which is preferably a hot stamping operation.

18. The process as claimed in claim 17, wherein steps c), e) and h) are carried out simultaneously by a single hot pressing operation, which is preferably a hot stamping operation.

19. The process as claimed in claim 18, further comprising:
i) producing a dish-shaped surface layer (6) so that, during step d) and/or step e), the surface layer (6) is capable of encompassing the intermediate layer (5), by bearing against the external face (2B).

20. The process as claimed in claim 19, wherein steps c), e), h) and i) are carried out simultaneously by a single hot pressing operation, which is preferably a hot stamping operation.

21. The process as claimed in claim 14, wherein the vessel (1) is made from an austenitic stainless steel blank, the intermediate layer (5) is made from an aluminum and/or copper blank, the surface layer (6) is made from a ferritic stainless steel blank, and the ornamental piece (7) is made from a blank based on one or more of the following materials: copper, titanium, brass, iron, nickel, steel.

22. A process for manufacturing one of the utensils of the following group: pressure cooker, saucepan, skillet, cooking pot, kettle, in accordance with the process of claim 14.
